(19) United States
(12) Patent Application Publication
(10) Pub. No.: US 2010/0077383 A1
(43) Pub. Date: Mar. 25, 2010

(54) SIMULATION METHOD AND STORAGE MEDIUM FOR STORING PROGRAM

(75) Inventor: Manabu WATANABE, Tokyo (JP)

Correspondence Address: Fujitsu Patent Center;C/O CPA Global, P.O. Box 52050, Minneapolis, MN, 55402, US

(73) Assignee: FUJITSU MICROELECTRONICS LIMITED, Shinjuku-ku (JP)

(21) Appl. No.: 12/561,743

(22) Filed: Sep. 17, 2009

(30) Foreign Application Priority Data
Sep. 25, 2008 (JP) 2008-245954

(51) Int. Cl. G06F 9/44; G06F 9/45

(52) U.S. Cl. 717/124; 703/22

(57) ABSTRACT

A method for debugging software on a computer includes performing a simulation in which a signal undesired during normal operation is added to a signal value when the signal value is input to a plurality of external terminals included in hardware that executes the software and includes a processor and at least one input and output device, and judging whether or not a factor determining the signal value corresponding to the external terminal requested to display the signal value is the input from the outside to the hardware by checking whether or not the signal undesired during the normal operation is added.

### CROSS-REFERENCE TO RELATED APPLICATIONS

This application is based upon and claims the benefit of priority of the prior Japanese Patent Application No. 2008-245954, filed on Sep. 25, 2008, the entire contents of which are incorporated herein by reference.

### FIELD

The embodiments discussed herein are related to a simulation method and a storage medium for storing a program.

### BACKGROUND

In a typical environment for developing software of a microcomputer for built-in application, such as a microcomputer used for an electronic control unit (ECU) in an automobile, the software is debugged using a software simulator that simulates operations of a central processing unit (CPU), which include an execution of the software, and an input and output (I/O) simulator that simulates operations of an I/O resource.

As to the debugging of software, for example, Japanese Laid-Open Patent Publication No. 2004-220089 discusses a technique to improve debugging efficiency by indicating a bug in the software when an access to an I/O region or writing to a read only memory (ROM) region is performed. Further, for example, Japanese Laid-Open Patent Publication No. 02-118849 discusses a technique to perform simulations for a logical device, such as a CPU, in relation to two or more kinds of input and output devices.

For example, when a signal value of an external terminal is displayed while debugging software using the software simulator and the I/O simulator, it is difficult to judge whether the signal value is determined by an external factor, such as an input from outside of a microcomputer, or by an internal factor, such as an input caused by the software. Thus, there is a problem of reducing debugging efficiency.

### SUMMARY

According to an aspect of embodiments, a method for debugging software on a computer includes: performing a simulation in which a signal undesired during a normal operation is added to a signal value when the signal value is input as an input from outside to hardware to a plurality of external terminals included in the hardware that executes the software and includes a processor and at least one input and output device; and judging whether or not a factor determining the signal value corresponding to the external terminal requested to display the signal value is the input from the outside to the hardware by checking whether or not the signal undesired during the normal operation is added.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an embodiment;

FIG. 2 illustrates an example of execution environments to which the embodiment in FIG. 1 is applicable;

FIG. 3A illustrates an example of results that a warning information indication processor in FIG. 1 causes to be displayed;

FIG. 3B illustrates another example of the results that the warning information indication processor in FIG. 1 causes to be displayed;

FIG. 4 illustrates simulation processing according to the embodiment in FIG. 1;

FIG. 5 illustrates another embodiment; and

FIG. 6 illustrates simulation processing according to the embodiment in FIG. 5.

### DESCRIPTION OF EMBODIMENTS

Embodiments are described below with reference to the accompanying drawings.

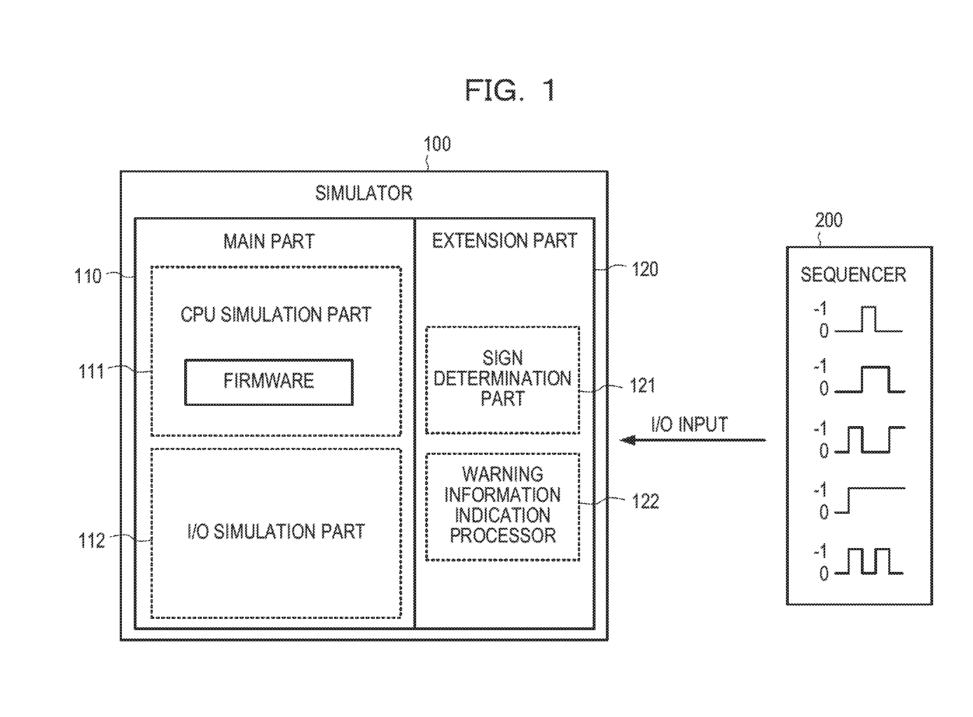

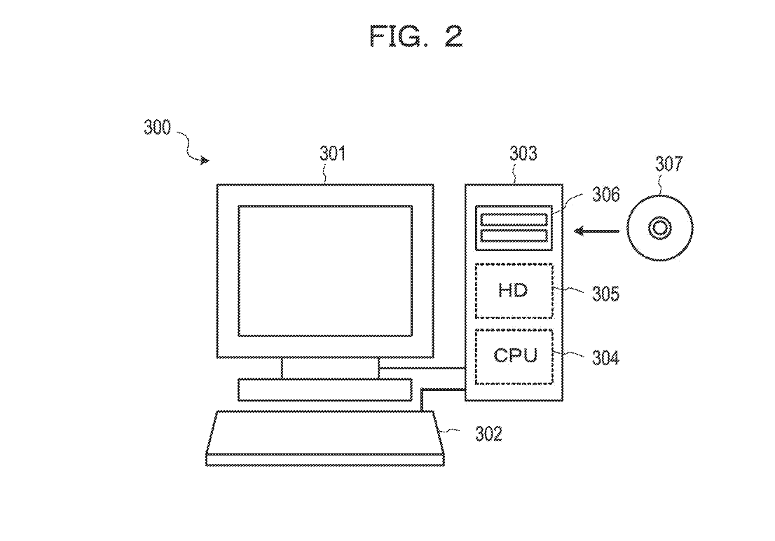

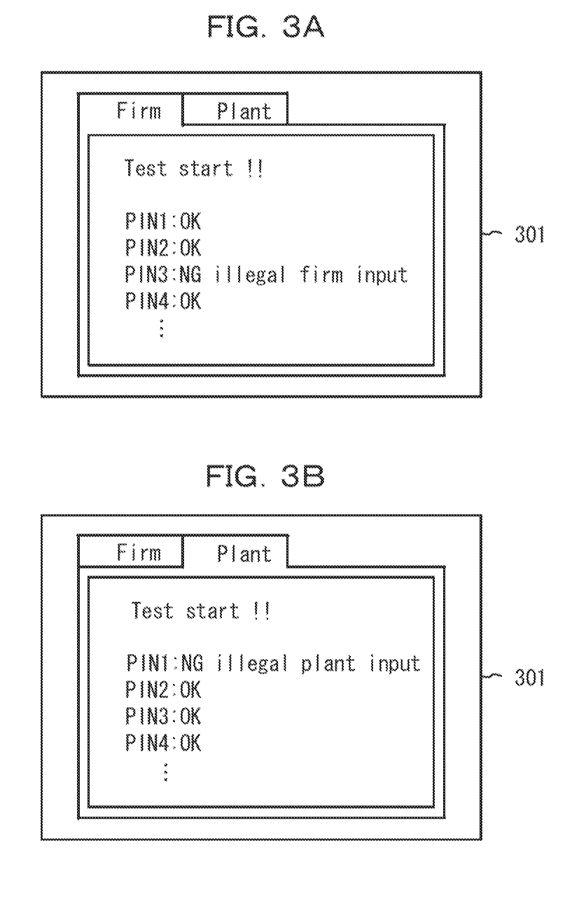

FIG. 1 illustrates an embodiment. FIG. 2 illustrates an example of execution environments to which the embodiment in FIG. 1 is applicable. FIG. 3A illustrates an example of results that a warning information indication processor in FIG. 1 causes to be displayed. FIG. 3B illustrates another example of the results that the warning information indication processor in FIG. 1 causes to be displayed.

In the embodiment in FIG. 1, software (e.g., firmware) is debugged in an environment for developing software of a microcomputer used for an ECU in an automobile based on simulation results obtained using a simulator 100 and a sequencer 200. In addition to a CPU 304, the microcomputer may include an I/O resource, such as an analog to digital converter (ADC), a watchdog timer, a universal asynchronous receiver transmitter (UART), an external interrupt unit, or an I/O port, for example.

As illustrated in FIG. 2, the simulator 100 and the sequencer 200 in FIG. 1 perform simulations on a workstation 300, for example. The workstation 300 includes a display 301, a keyboard 302, and a controller 303. The controller 303 includes the CPU 304, a hard disk drive (HDD) 305, and a recording medium drive 306. On the workstation 300, the HDD 305 stores a simulation program that is read out of a recording medium 307 through the recording medium drive 306. The simulator 100 and the sequencer 200 perform the simulations when the CPU 304 executes the simulation program stored in the HDD 305.

As further illustrated in FIG. 1, the simulator 100 includes a main unit 110 in which operations of the CPU 304 (firmware) and the I/O resource are simulated, and an extension part 120 that implements a function to indicate a signal value, a function to change the signal value, etc. The sequencer 200 is a tool for controlling inputs and outputs of each external terminal of the microcomputer during the simulating operations of the simulator 100. The sequencer 200 adds a signal undesired during normal operation to the signal value when the signal value is input to each external terminal as an I/O input from outside of the microcomputer. For example, the sequencer 200 may add “−” (a minus sign) to the signal value when the signal value is input to each external terminal. For example, the sequencer 200 may set the signal value to be “0” or “−1” in inputting the signal value to each external terminal. Thus, for example, when the signal value of the external terminal is displayed on a screen of the display 301 in accordance with a simulation command and the like, whether the I/O input caused by the sequencer 200 determines the signal value or whether the I/O input caused by the firmware determines the signal value may be judged through checking whether or not “−” is added to the signal value. Alternatively, the sequencer 200 may set the signal value to be “−0” or “−1” in inputting the signal value to each external terminal. The value “−0” is distinguished from “0” using the complement of 1 for example.

As further illustrated in FIG. 1, the main unit 110 of the simulator 100 includes a CPU simulation part 111 for simulating the operations of the CPU 304 and an I/O simulation part 112 for simulating the operations of the I/O resource. The signal value of each external terminal is processed as the absolute value in the main unit 110. As a result, the simulations may be performed without any trouble even when “−” is added to the signal value of each external terminal. Known techniques may be applicable to the CPU simulation part 111 (software simulator) and the I/O simulation part 112 (I/O simulator). Therefore, detailed descriptions thereof are omitted herein.

As further illustrated in FIG. 1, the extension part 120 of the simulator 100 includes a sign determination part 121 and a warning information indication processor 122. The sign determination part 121 checks whether or not the signal value of the external terminal at which an I/O input occurs exceeds 0 and determines the sign of the signal value based on the result of the check. The result on the sign determined by the sign determination part 121 is provided to the main unit 110 along with the signal value of the external terminal at which the I/O input occurs.

As illustrated in FIG. 3A, when the sign of the signal value of the external terminal at which an I/O input occurs is determined by the sign determination part 121 in FIG. 1 not to be “−”, the warning information display processor 122 in FIG. 1 causes the screen of the display 301 in FIG. 2 to display, for example, information “NG” for indicating that the abnormal I/O input caused by the firmware has occurred and the warning message “illegal firm input”. When the sign of the signal value of the external terminal at which the I/O input occurs is determined by the sign determination part 121 in FIG. 1 to be “−”, the warning information display processor 122 in FIG. 1 causes the screen of the display 301 in FIG. 2 to display information “OK” for indicating that the I/O input caused by the sequencer 200 in FIG. 1 has occurred. The displayed result in FIG. 3A indicates that the I/O input caused by the sequencer 200 in FIG. 1 occurs at each of the external terminals PIN 1, PIN 2, and PIN 4, and that the abnormal I/O input caused by the firmware occurs at the external terminal PIN 3. As a result, which external terminal receives the abnormal I/O input caused by the firmware may be identified.

As illustrated in FIG. 3B, when the firmware seems to operate normally and the signal value that the sequencer 200 in FIG. 1 inputs to each external terminal is obtained using a real machine, for example, and when the sign of the signal value of the external terminal at which an I/O input occurs is determined by the sign determination part 121 in FIG. 1 not to be “−”, the warning information indication processor 122 in FIG. 1 may also cause the screen of the display 301 in FIG. 2 to display the information “NG” for indicating that the I/O input from the outside of the microcomputer is abnormal along with the warning message “illegal plant input”. In such a case, the warning information indication processor 122 in FIG. 1 causes the screen of the display 301 in FIG. 2 to display the information “OK” for indicating that the I/O input from the outside of the microcomputer is normal when the sign of the signal value of the external terminal at which the I/O input occurs is determined by the sign determination part 121 in FIG. 1 to be “−”. The displayed result in FIG. 3B indicates that the I/O input from the outside of the microcomputer to the external terminal PIN 1 is abnormal and that the I/O inputs from the outside of the microcomputer to the external terminals PIN 2, PIN 3, and PIN 4 are normal. As a result, which external terminal receives the abnormal I/O input from the outside of the microcomputer may be readily identified.

Further, when the sign of the signal value of the external terminal at which an I/O input occurs is determined by the sign determination part 121 in FIG. 1 not to be “−”, the warning information indication processor 122 in FIG. 1 may cause the screen of the display 301 in FIG. 2 to display information for giving a warning about data of the I/O resource and/or a way of using the I/O resource, for example, based on the type of the I/O resource corresponding to the external terminal. For example, when the I/O resource corresponding to the external terminal at which the I/O input occurs is the ADC, the warning message for indicating that the abnormal I/O input caused by the firmware has occurred may be displayed along with analog input data. When the I/O resource corresponding to the external terminal at which the I/O input occurs is the external interrupt unit, a set register value, such as an interrupt mask, may be displayed. As a result, a problematic portion in the firmware may be identified.

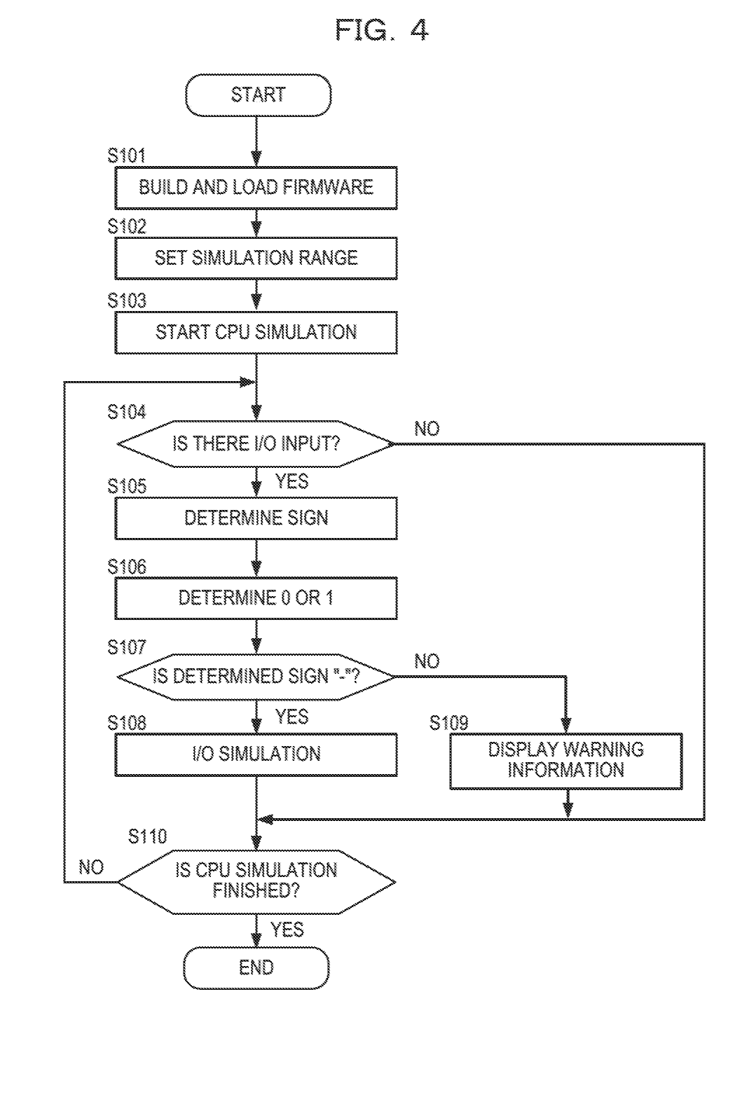

FIG. 4 illustrates simulation processing according to the embodiment in FIG. 1.

As illustrated in FIG. 4, in the embodiment in FIG. 1, the simulator 100 and the sequencer 200 in FIG. 1 perform the simulations to debug the firmware based on simulation processing (Operations S101 to S110). The firmware under development is loaded into the main unit 110 (the CPU simulation part 111) of the simulator 100 in FIG. 1 after having been built (compiled and linked), and the simulation processing proceeds to Operation S102 (Operation S101). A simulation range (for example, an ending address for the simulation) is set for the simulator 100 in FIG. 1, and the simulation processing proceeds to Operation S103 (Operation S102). The simulation of the CPU (the simulation of the firmware) starts in the main unit 110 (the CPU simulation part 111) of the simulator 100 in FIG. 1, and the simulation processing proceeds to Operation S104 (Operation S103). Whether or not an I/O input occurs is judged in the extension part 120 (the sign determination part 121) in FIG. 1 of the simulator 100 in FIG. 1. When it is judged that an I/O input occurs in Operation S104, the simulation processing proceeds to Operation S105. When it is judged that no I/O inputs occur in Operation S104, the simulation processing proceeds to Operation S110 (Operation S104). The sign of the signal value of the external terminal at which the I/O input occurs is determined in the extension part 120 (the sign determination part 121) in FIG. 1 of the simulator 100 in FIG. 1, and the simulation processing proceeds to Operation S106 (Operation S105). In the main unit 110 (the I/O simulation part 112) in FIG. 1 of the simulator 100 in FIG. 1, whether the signal value of the external terminal at which the I/O input occurs is 0 or 1 is determined, and the simulation processing proceeds to Operation S107 (Operation S106). Whether or not the sign determined in the extension part 120 (the warning information indication processor 122) in FIG. 1 of the simulator 100 in FIG. 1 in Operation S105 is “−” is checked. When the sign determined in Operation S107 is “−”, the simulation processing proceeds to Operation S108. When the sign determined in Operation S107 is not “−”, the simulation processing proceeds to Operation S109 (Operation S107). The simulation of the I/O resource corresponding to the external terminal at which the I/O input occurs is performed in the main unit 110 (the I/O simulation part 112) in FIG. 1 of the simulator 100 in FIG. 1 and the simulation processing proceeds to Operation S110 (Operation S108). The extension part 120 (the warning information indication processor 122) in FIG. 1 of the simulator 100 in FIG. 1 causes the screen of the display 301 to display the warning information regarding the I/O resource corresponding to the external terminal at which the I/O input occurs, such as the information for warning at least the data of the I/O resource or the way of using the I/O resource, and the simulation processing proceeds to Operation S110 (Operation S109). Whether or not the CPU simulation may be finished is determined in the main unit 110 (the CPU simulation part 111) in FIG. 1 of the simulator 100 in FIG. 1 based on the simulation range set in Operation S102. When the end of the CPU simulation is determined, the simulation processing is completed. When the CPU simulation is determined in Operation S110 not to have ended, the simulation processing proceeds to Operation S104 (Operation S110).

In the simulations in FIG. 4 as described above, since the warning information regarding the I/O resource corresponding to the external terminal at which the abnormal I/O input caused by the firmware occurs, such as the information for warning at least the data of the I/O resource or the way of using the I/O resource, is displayed, a problematic portion in the firmware may be identified.

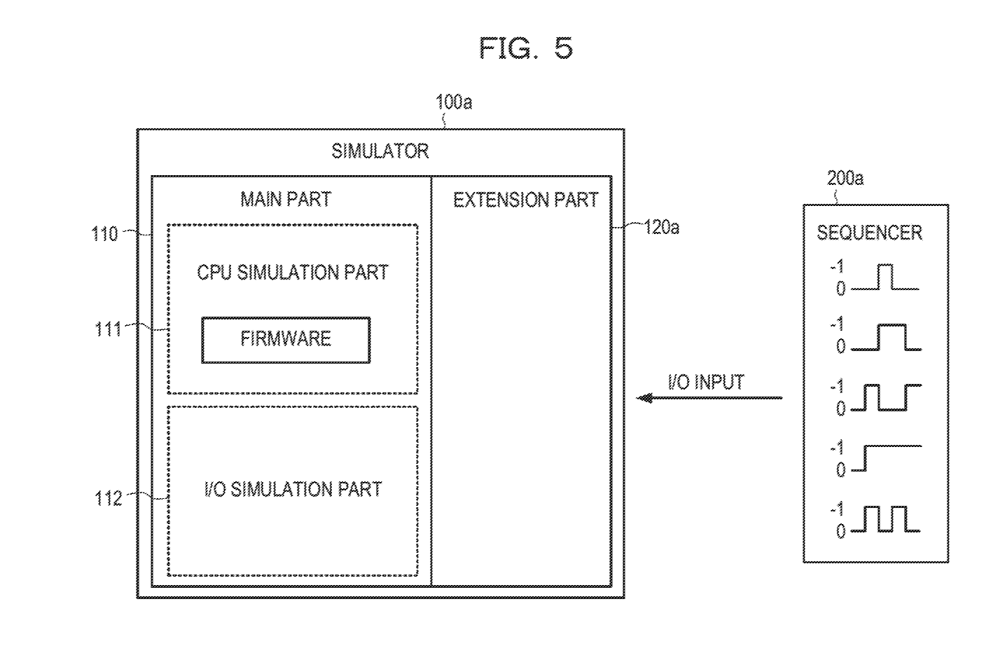

FIG. 5 illustrates another embodiment. The same elements as the elements described in the preceding embodiment in FIG. 1 are given the same reference numerals and detailed explanations thereof are omitted.

In the embodiment in FIG. 5, firmware is debugged in an environment for developing software of a microcomputer used for an ECU in an automobile based on simulation results obtained using a simulator 100a and a sequencer 200a. Similar to the preceding embodiment in FIG. 1, the simulator 100a and the sequencer 200a perform simulations on the workstation 300 in FIG. 2, for example.

As further illustrated in FIG. 5, the simulator 100a includes a main unit 110 and an extension part 120a. The extension part 120a is obtained by removing the sign determination part 121 and the warning information indication processor 122 from the extension part 120 in FIG. 1. The sequencer 200a is a tool for controlling inputs and outputs of each external terminal of the microcomputer during the simulating operations of the simulator 100a. The sequencer 200a sets a signal value to be “0” or “1” in inputting the signal value to each external terminal as the I/O input from outside of the microcomputer. According to the embodiment in FIG. 5, when the signal value of the external terminal is displayed in accordance with the simulation command and the like, it may be difficult to judge whether the I/O input caused by the sequencer 200a determines the signal value or the I/O input caused by the firmware determines the signal value by checking whether or not “−” is added to the signal value.

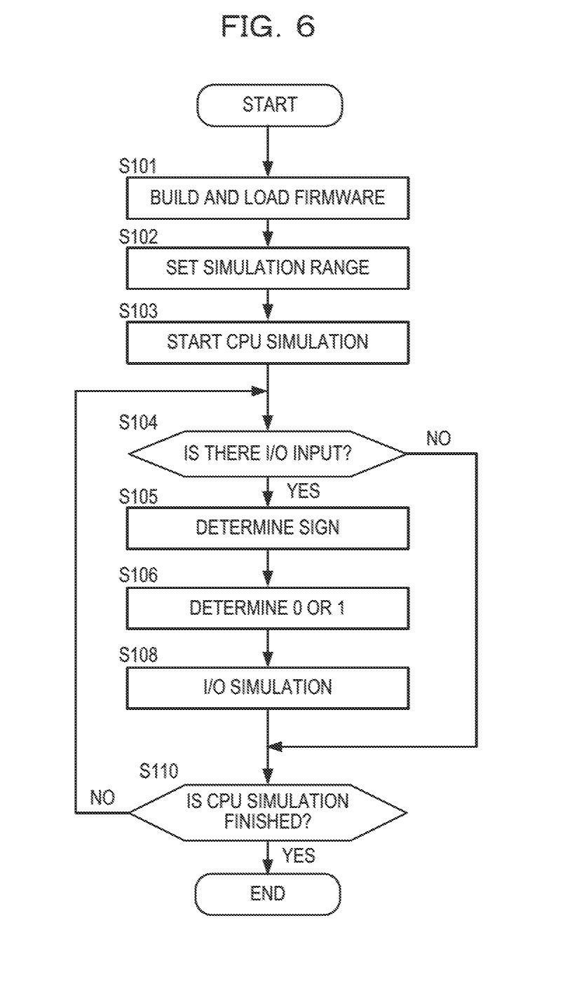

FIG. 6 illustrates an example of the simulations according to the embodiment in FIG. 5.

As illustrated in FIG. 6, in the embodiment in FIG. 5, the simulator 100a in FIG. 6 and the sequencer 200a in FIG. 6 perform the simulations to debug the firmware based on simulation processing, for example, Operations S101 to S104, S106, S108, and S110. The simulation processing does not include Operations S105, S107, and S109 of the simulation processing in FIG. 4. According to the embodiment in FIG. 5, it may be difficult to judge whether or not the abnormal I/O input caused by the firmware has occurred. As a result, the debugging efficiency may be considerably reduced.

However, as described above in the embodiment in FIG. 1, when the signal value of the external terminal is displayed in accordance with the simulation command, for example, whether the I/O input caused by the sequencer 200 determines the signal value or the I/O input caused by the firmware determines the signal value may be readily judged through checking whether or not “−” is added to the signal value. Since the warning information regarding the I/O resource corresponding to the external terminal at which the abnormal I/O input caused by the firmware has occurred, such as the information for giving a warning about the data of the I/O resource and/or the way of using the I/O resource, for example, is displayed, it may be judged whether or not the abnormal I/O input caused by the firmware occurs. In addition, a problematic portion in the firmware may be detected. As a result, the firmware may be efficiently debugged to shorten a period of developing the firmware.

According to the embodiments, the factor that determines the signal value of the external terminal may be identified in debugging the software executed by the hardware including the CPU and at least one input and output device based on the simulation results. As a result, the debugging efficiency may be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for debugging software on a computer, comprising:
performing a simulation in which a signal undesired during normal operation is added to a signal value when the signal value is input as an input from outside to hardware to a plurality of external terminals included in the hardware that executes the software and includes a processor and at least one input and output device; and
judging whether or not a factor determining the signal value corresponding to the external terminal requested to display the signal value is the input from the outside to the hardware by checking whether or not the signal undesired during the normal operation is added.

2. The method according to claim 1,
wherein warning information is displayed for the external terminal requested to display the signal value when the signal undesired during the normal operation is judged not to be added.

3. The method according to claim 2,
wherein the warning information is information for warning of an occurrence of an abnormal input caused by the software.

4. The method according to claim 2,
wherein the warning information is information for warning that the input from the outside of the hardware is abnormal.

5. The method according to claim 2,
wherein the warning information is information for warning that a way of using the input and output device corresponding to the external terminal requested to display the signal value is abnormal.

6. The method according to claim 1,
wherein the signal undesired during the normal operation has a minus sign.

7. A computer-readable recording medium adapted to store a program for debugging software on a computer, the program causing the computer to execute operations of:
performing a simulation in which a signal undesired during normal operation is added to a signal value when the signal value is input as an input from outside to hardware to a plurality of external terminals included in the hardware that executes the software and includes a processor and at least one input and output device; and
judging whether or not a factor determining the signal value of the external terminal requested to display the signal value is the input from the outside to the hardware by checking whether or not the signal undesired during the normal operation is added.

8. The program according to claim 7, causing the computer to display warning information for the external terminal requested to display the signal value when the signal undesired during the normal operation is judged not to be added.

9. The program according to claim 8,
wherein the warning information is information for warning of an occurrence of an abnormal input caused by the software.

10. The program according to claim 8,
wherein the warning information is information for warning that the input from the outside of the hardware is abnormal.

11. The program according to claim 8,
wherein the warning information is information for warning that a way of using the input and output device corresponding to the external terminal requested to display the signal value is abnormal.

12. The program according to claim 8,
wherein the signal undesired during the normal operation has a minus sign.
